(19) United States
(12) Patent Application Publication
(10) Pub. No.: US 2004/0259523 A1
(43) Pub. Date: Dec. 23, 2004

(54) Wireless meter reading (WMR)

(76) Inventor: Thomas L. Stenger, Papaikou, HI (US)

Correspondence Address: Thomas L. Stenger, 27-356 Kaapoko Homestead R., Papaikou, HI, 96781, US

(21) Appl. No.: 10/461,972

(22) Filed: Jun. 16, 2003

(51) Int. Cl. H04M 11/00

(52) U.S. Cl. 455/405

(57) ABSTRACT

The nature of this invention is to allow for the reading of utility meters water, gas and electric, to be done remotely, and the results transmitted by wireless means to a receiver, so that utility company's can do away with manual labor in this operation. This will cut costs and time and increase accuracy in this business operation. This is a new concept since meter reading is done in person by a meter reader, or by approximation at the present time.

This invention, which is, the process of wireless transmitting meter readings, is intending to be used, to make it possible for utility company's (electric, water, and gas) to be able to read their meters and have the results transmitted via wireless transmission to a receiver so they can keep track of, and bill for their customer's usage.

### BACKGROUND OF THE INVENTION

This patent covers the concept of transmitting these reading by wireless method from a transmitter to a receiver, so local readings by human sight will no longer be required. This patent will allow for the development of equipment to facilitate the reading transmitting and receiving of meter reading, and will save utility company moneys spent on persons now hired to perform this operation.

### DESCRIPTION OF DRAWING

FIG. 1A. This drawing shows the concept of taking the reading from a meter and sending it by a transmitter via wireless transmission and receiving it by a receiver so it can by used by the utility company to record customer usage and facilitate billing.

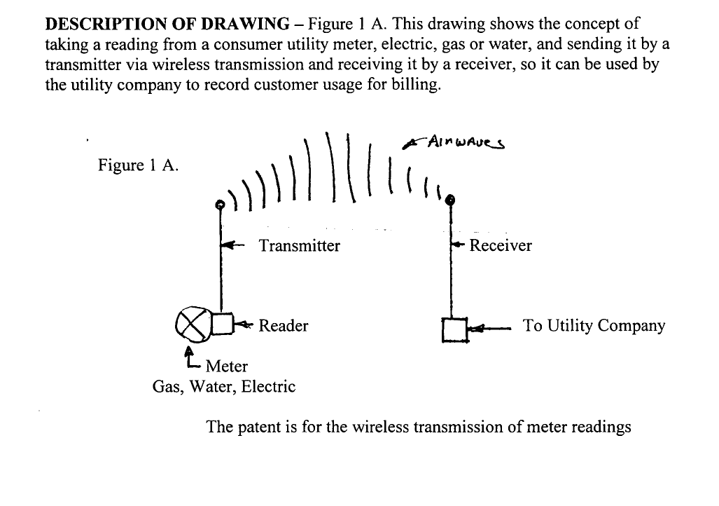

[image]

1. What I claim as my invention for this patent is, the idea of the wireless transmission of meter readings for all, electric, gas, and water customers, by the way of wireless transmission, by micro wave, or radio wave, or cell phone, or any other means through the airwaves to a receiver, for the purpose of billing and keeping track of the usage for all public and commercial utility customers.
